(19) United States
(12) Patent Application Publication
(10) Pub. No.: US 2025/0211309 A1
(43) Pub. Date: Jun. 26, 2025

(54) DATA COLLECTION METHOD FOR BEAM MANAGEMENT BASED ON MACHINE LEARNING AND WIRELESS COMMUNICATION DEVICE

(71) Applicant: SHENZHEN TCL NEW TECHNOLOGY CO., LTD., Shenzhen, Guangdong (CN)

(72) Inventor: Jia SHENG, Shenzhen, Guangdong (CN)

(73) Assignee: SHENZHEN TCL NEW TECHNOLOGY CO., LTD., Shenzhen, Guangdong (CN)

(21) Appl. No.: 18/851,048

(22) PCT Filed: Mar. 31, 2022
(86) PCT No.: PCT/CN2022/084582

§ 371 Date: Sep. 25, 2024

(51) Int. Cl. H04B 7/06; H04B 17/309; H04L 25/02; H04W 64/00; H04W 74/0833

(52) U.S. Cl. CPC H04B 7/06952; H04B 17/309; H04L 25/0202; H04W 64/00; H04W 74/0833

(57) ABSTRACT

The disclosure provides a data collection method for beam management based on machine learning (ML). At least one wireless communication device includes a combination of base stations and user equipment (UE). The least one wireless communication device executes the data collection method to collect data units for beam management based on machine learning. The data units associate at least one beam with at least one attribute, and each data unit in the data units associates a beam with at least one attribute. A machine learning model is trained by the data units to a machine learning model and outputs a beam operation advice. The machine learning model operates in relation to a channel-estimation-based beam management function that outputs a channel estimation result. A beam operation is performed based on the beam operation advice and the channel estimation result.

### TECHNICAL FIELD

The present disclosure relates to the field of communication systems, and more particularly, to a data collection method for beam management based on machine learning and a wireless communication device.

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) that provide wireless links to the UEs located in cells covered by the base station, and an interface to a core network (CN) which provides overall network control. As will be appreciated the RAN and CN each conduct respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB.

### Technical Problem

In 3GPP Rel-18, a study item (SI) “Artificial Intelligence (AI)/Machine Learning (ML) for NR Air Interface” will start to develop. According to real use scenarios, various data should be collected for Machine Learning model management.

Typically, the beam selection is based on the measurement of channel state information (CSI)-reference signal (CSI-RS)/synchronization signal block (SSB). This process costs a large amount of reference signals and delay. Thus, predictive beam switching is proposed to reduce the delay. Applying ML to beam management is to be studied. Currently, the data format and how the data is collected is unknown.

### Technical Solution

An object of the present disclosure is to propose a wireless communication device, such as a user equipment (UE) or a base station, and a data collection method for beam management based on machine learning.

In a first aspect, an embodiment of the invention provides a data collection method for beam management based on machine learning, executable in at least one wireless communication device, comprising:

collecting data units for beam management based on machine learning, wherein the data units associate a plurality of beams with a plurality of attributes, and each data unit in the data units associates a beam with at least one attribute.

In a second aspect, an embodiment of the invention provides a wireless communication device comprising a processor configured to call and run a computer program stored in a memory, to cause a device in which the processor is installed to execute the disclosed method.

The disclosed method may be implemented in a chip. The chip may include a processor, configured to call and run a computer program stored in a memory, to cause a device in which the chip is installed to execute the disclosed method.

The disclosed method may be programmed as computer-executable instructions stored in non-transitory computer-readable medium. The non-transitory computer-readable medium, when loaded to a computer, directs a processor of the computer to execute the disclosed method.

The non-transitory computer-readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as a computer program product, which causes a computer to execute the disclosed method.

The disclosed method may be programmed as a computer program, which causes a computer to execute the disclosed method.

### Advantageous Effects

The invention provides embodiments to address problems in beam management.
Some embodiments of the disclosure include data collection in beam management. Various schemes of data collection may be used for different functions in beam management. In particular, the data collection can be performed at one gNB and shared between two gNBs or performed at two gNBs.
Some embodiments of the disclosure provide predictive beam failure recovery and facilitate efficient beam failure detection and robust beam selection.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure. A person having ordinary skill in this field can obtain other figures according to these figures without paying the premise.

FIG. 1 illustrates a schematic view showing an example wireless communication system comprising a user equipment (UE), a base station, and a network entity.

FIG. 2 illustrates a schematic view showing a system for executing a data collection method for beam management based on machine learning.

FIG. 3 illustrates a schematic view showing an embodiment of the disclosed method.

FIG. 4 illustrates a schematic view showing a first embodiment of the data collection method for beam management based on machine learning.

FIG. 5 illustrates a schematic view showing a second embodiment of the data collection method for beam management based on machine learning.

FIG. 6 illustrates a schematic view showing a third embodiment of the data collection method for beam management based on machine learning.

FIG. 7 illustrates a schematic view showing an example of data sharing between two base stations.

FIG. 8 illustrates a schematic view showing another example of data sharing between two base stations using a mapping function.

FIG. 9 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The disclosure provides a data collection method for beam management based on machine learning and a wireless communication device. Embodiments of the disclosure provide data collection methods and use cases of beam management based on machine learning, e.g., beam failure recovery for the wireless communication device.

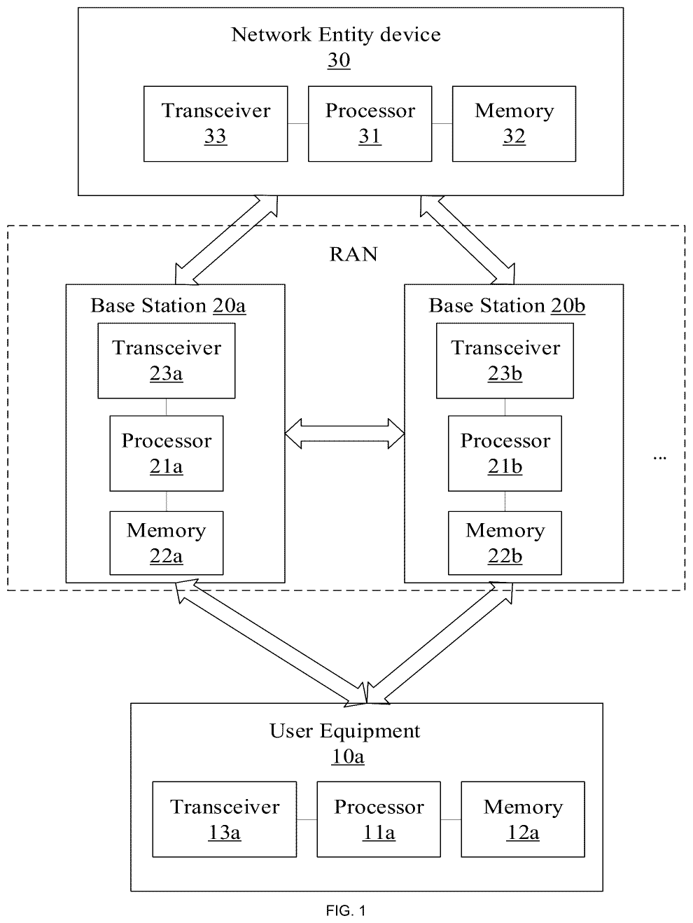

With reference to FIG. 1, a telecommunication system including a UE 10a, a base station 20a, a base station 20b, and a network entity device 30 executes the disclosed method according to an embodiment of the present disclosure. FIG. 1 is shown for illustrative not limiting, and the system may comprise more UEs, BSs, and CN entities. Connections between devices and device components are shown as lines and arrows in the FIGs. The UE 10a may include a processor 11a, a memory 12a, and a transceiver 13a. The base station 20a may include a processor 21a, a memory 22a, and a transceiver 23a. The base station 20b may include a processor 21b, a memory 22b, and a transceiver 23b. The network entity device 30 may include a processor 31, a memory 32, and a transceiver 33. Each of the processors 11a, 21a, 21b, and 31 may be configured to implement proposed functions, procedures, and/or methods described in this description. Layers of radio interface protocol may be implemented in the processors 11a, 21a, 21b, and 31. Each of the memory 12a, 22a, 22b, and 32 operatively stores a variety of programs and information to operate a connected processor. Each of the transceivers 13a, 23a, 23b, and 33 is operatively coupled with a connected processor, transmits and/or receives a radio signal. Each of the base stations 20a and 20b may be an eNB, a gNB, or one of other radio nodes.

Each of the processors 11a, 21a, 21b, and 31 may include a general-purpose central processing unit (CPU), application-specific integrated circuits (ASICs), other chipsets, logic circuits and/or data processing devices. Each of the memory 12a, 22a, 22b, and 32 may include read-only memory (ROM), a random-access memory (RAM), a flash memory, a memory card, a storage medium and/or other storage devices. Each of the transceivers 13a, 23a, 23b, and 33 may include baseband circuitry and radio frequency (RF) circuitry to process radio frequency signals. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art.

The network entity device 30 may be a node in a CN. CN may include LTE CN or 5GC which may include user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and the network exposure function (NEF).

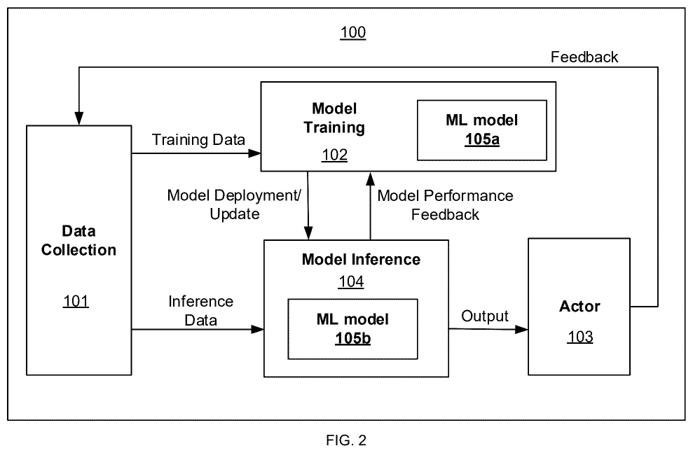

With reference to FIG. 2, a system 100 for the data collection method for beam management based on machine learning comprises units of data collection 101, model training unit 102, actor 103, and model inference 104. Please note that FIG. 2 does not necessarily limit the data collection method to the instant example. The data collection method is applicable to any designs for beam management based on machine learning. The general steps comprise, data collection and/or model training and/or model inference and/or (an) actor(s).

The data collection unit 101 is a function that provides input data to the model training unit 102 and the model inference unit 104. AI/ML algorithm specific data preparation (e.g., data pre-processing and cleaning, formatting, and transformation) is not carried out in the data collection unit 101.

Examples of input data may include measurements from UEs or different network entities, feedback from Actor 103, output from an AI/ML model.

Training data is data needed as input for the AI/ML Model training unit 102.

Inference data is data needed as input for the AI/ML Model inference unit 104.

The model training unit 102 is a function that performs the ML model training, validation, and testing. The Model training unit 102 is also responsible for data preparation (e.g., data pre-processing and cleaning, formatting, and transformation) based on training data delivered by the data collection unit 101, if required.

Model Deployment/Update between unit 102 and 104 involves deploy or update an AI/ML model (e.g., a trained machine learning model 105a or 105b) to the model inference unit 104. The model training unit 102 uses data units as training data to train a machine learning model 105a and generates a trained machine learning model 105b from the machine learning model 105a.

The model inference unit 104 is a function that provides AI/ML model inference output (e.g., predictions or decisions). The AI/ML model inference output is the output of the machine learning model 105b. The Model inference unit 104 is also responsible for data preparation (e.g., data pre-processing and cleaning, formatting, and transformation) based on inference data delivered by the data collection unit 101, if required.

Output shown between unit 103 and unit 104 is the inference output of the AI/ML model produced by the model inference unit 104.

Actor 103 is a function that receives the output from the model inference unit 104 and triggers or performs corresponding actions. The actor 103 may trigger actions directed to other entities or to itself.

Feedback between unit 103 and unit 101 is information that may be needed to derive training or inference data or performance feedback.

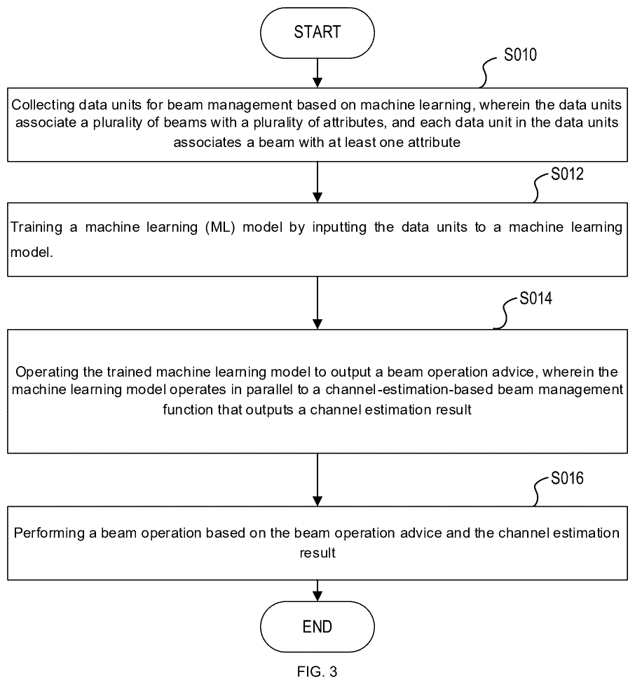

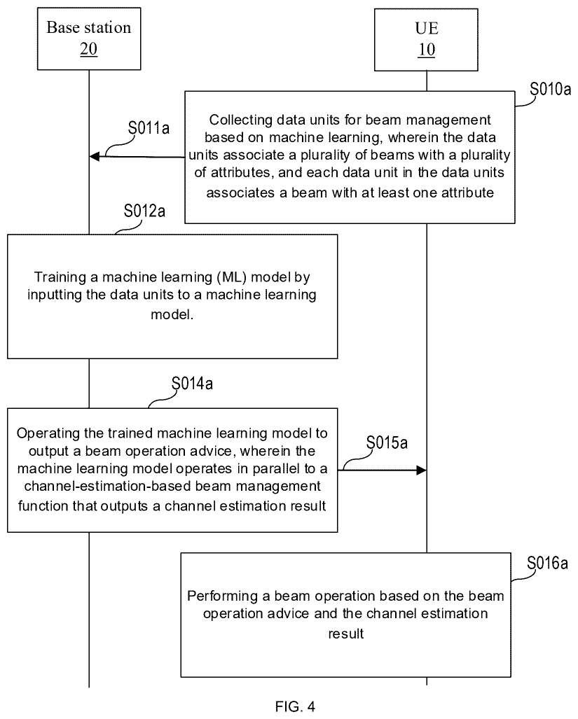

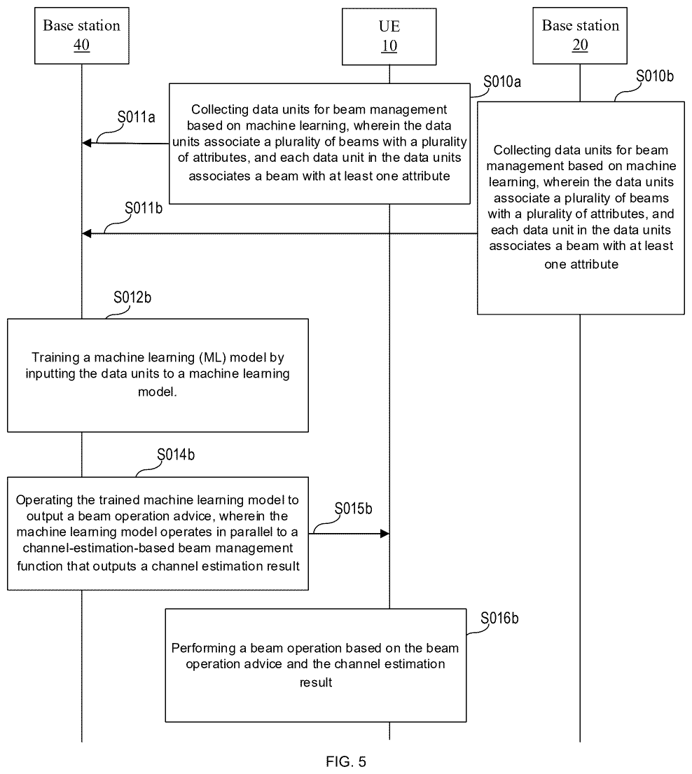

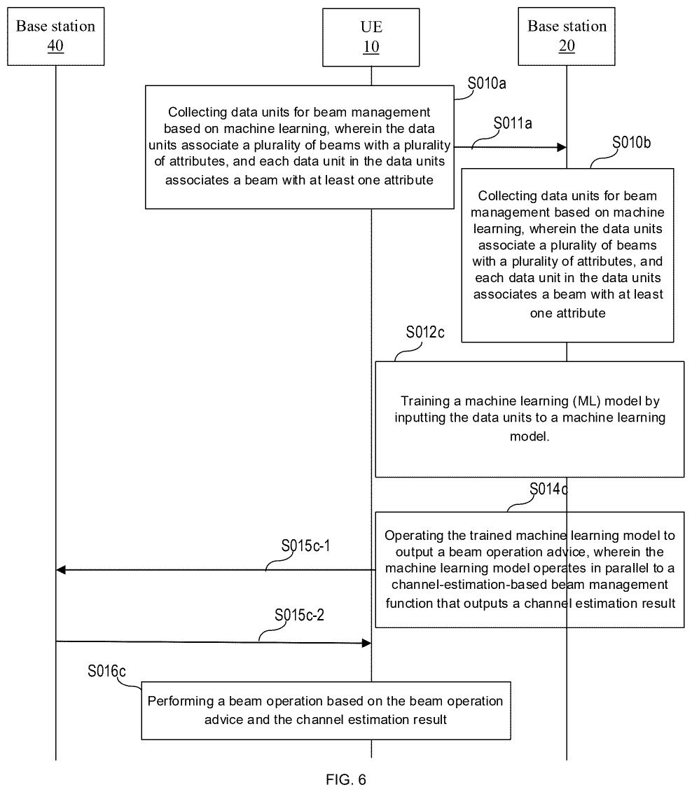

With reference to FIG. 3, FIG. 4, FIG. 5 and FIG. 6, an example of a UE 10 in the description may include one of the UE 10a. Examples of a gNB 20 and gNB 40 in the description may include the base station 20a or 20b. Note that even though the gNB is described as an example of base station in the following, the disclosed method of may be implemented in any other types of base stations, such as an eNB or a base station for beyond 5G. Uplink (UL) transmission of a control signal or data may be a transmission operation from a UE to a base station. Downlink (DL) transmission of a control signal or data may be a transmission operation from a base station to a UE. The disclosed method is detailed in the following. The UE 10 and a base station, such as a gNB 20 or 40, execute the data collection method for beam management based on machine learning.

FIG. 3 shows an embodiment of the disclosed method. At least one wireless communication device executes a data collection method for beam management based on machine learning. In an embodiment, the at least one wireless communication device may comprise a user equipment (UE). In another embodiment, the at least one wireless communication device may comprise a base station. In still another embodiment, the at least one wireless communication device may comprise a combination of UEs and base stations.

The at least one wireless communication device collects data units for beam management based on machine learning, wherein the data units associate a plurality of beams with a plurality of attributes, and each data unit in the data units associates a beam with at least one attribute (S010). In an embodiment, the data collection unit 101 performs the collecting of data units in the S010. The data unit comprises a beam name, a beam index, or a beam identifier of the beam to identify the beam in the data unit. Alternatively, the data unit may comprise a quasi-co-location (QCL) relationship or a transmission configuration indicator (TCI) state denoting the beam.

The at least one attribute in the data unit comprises measurement on the beam associated by the data unit. The measurement on the beam associated by the data unit comprises a reference signal received power (RSRP), and/or reference signal received quality (RSRQ), and/or hypothetical block error rate (BLER). The measurement on the beam associated by the data unit comprises a quantized measurement value or yet-quantized measurement value. For example, the quantized measurement value is one when the beam in a time unit has a measurement value greater than a threshold, and the quantized measurement value is zero when the beam in a time unit has a measurement value no greater than the threshold. For example, the threshold is signaled to a UE via DCI field and/or RRC signaling. In still another example, if a second gNB is responsible for data collection, the threshold value is signaling by a first gNB via X2/Xn interface.

In some embodiment the data unit report comprises averaged results. In some embodiment the report from UE comprises packaged results including the results measured/produced from a starting time t_0 and a time duration of t_report_window. The t_report_window is determined by a gNB and/or a UE according to its capability. The packaged results are organized/listed by their respective log time.

In an embodiment, the at least one attribute in the data unit comprises location information of the at least one wireless communication device. In another embodiment, the at least one attribute in the data unit comprises a connection duration of the at least one wireless communication device on the beam associated by the data unit.

In an embodiment the at least one attribute in the data unites comprise the feedback information to access the Machine Learning model performance

In some embodiment the at least one attribute in the data unit comprises a combination of the beam related indication aforementioned.

The at least one wireless communication device trains a machine learning (ML) model by inputting the data units to a machine learning model (S012). In an embodiment, the model training unit 102 trains the machine learning model 105a by inputting the data units to the machine learning model 105a as shown in S012 and obtains the trained machine learning model 105b.

The at least one wireless communication device deploys and operates the trained machine learning model to output a beam operation advice, wherein the machine learning model operates in relation to a current channel-estimation-based beam management function that outputs a channel estimation result (S014). The relation may comprise a parallel relation in which the machine learning model operates in parallel to the current channel-estimation-based beam management function. The relation may comprise a substitution relation in which the machine learning model operates in substitution for the current channel-estimation-based beam management function. For example, an output of the machine learning model operates replace an output of the current channel-estimation-based beam management function. In an embodiment, the model inference unit 104 operates the trained machine learning model 105b to output a beam operation advice as an inference output. In some embodiment, the machine learning model is deployed at gNB. In some embodiment the machine learning model is deployed at UE side for beam management, e.g., beam failure recovery.

The at least one wireless communication device performs a beam operation based on the beam operation advice and the channel estimation result (S016). In an embodiment, the actor 103 performs a beam operation based on the beam operation advice and the channel estimation result as shown in S016.

With reference to FIG. 4, the UE10 collects data units for beam management based on machine learning, wherein the data units associate a plurality of beams with a plurality of attributes, and each data unit in the data units associates a beam with at least one attribute (S010a). In an embodiment, the data collection unit 101 performs the collecting of data units in the S010a. The UE 10 reports the data units to the gNB 20 (S011a). The gNB 20 receives the data units.

The gNB 20 trains a machine learning (ML) model by inputting the data units to a machine learning model (S012a). In an embodiment, the model training unit 102 trains the machine learning model 105a by inputting the data units to the machine learning model 105a as shown in S012a and obtains the trained machine learning model 105b.

The gNB 20 deploys and operates the trained machine learning model to output a beam operation advice, wherein the machine learning model operates in relation to a channel-estimation-based beam management function that outputs a channel estimation result (S014a). The relation may comprise a parallel relation in which the machine learning model operates in parallel to the current channel-estimation-based beam management function. The relation may comprise a substitution relation in which the machine learning model operates in substitution for the current channel-estimation-based beam management function. For example, an output of the machine learning model operates replace an output of the current channel-estimation-based beam management function. In an embodiment, the model inference unit 104 operates the trained machine learning model 105b to output a beam operation advice as an inference output. The gNB 20 transmits the beam operation advice as an inference output in an indication to the UE 10 (S015a). The UE 10 receives the indication comprising the beam operation advice.

The UE 10 performs a beam operation based on the beam operation advice and the channel estimation result (S016a). In an embodiment, the actor 103 performs a beam operation based on the beam operation advice and the channel estimation result as shown in S016a.

With reference to FIG. 5, the UE 10 collects data units for beam management based on machine learning, wherein the data units associate a plurality of beams with a plurality of attributes, and each data unit in the data units associates a beam with at least one attribute (S010a). In an embodiment, the data collection unit 101 performs the collecting of data units in the S010a. The UE 10 reports the data units to the gNB 40 (S011a). The gNB 40 receives the data units.

The gNB 20 collects data units for beam management based on machine learning, wherein the data units associate a plurality of beams with a plurality of attributes, and each data unit in the data units associates a beam with at least one attribute (S010b). In an embodiment, the data collection unit 101 performs the collecting of data units in the S010b. The gNB 20 reports the data units to the gNB 40 (S011b). The gNB 40 receives the data units.

The gNB 40 trains a machine learning (ML) model by inputting the data units to a machine learning model (S012b). In an embodiment, the model training unit 102 trains the machine learning model 105a by inputting the data units to the machine learning model 105a as shown in S012b and obtains the trained machine learning model 105b.

The gNB 40 operates the trained machine learning model to output a beam operation advice, wherein the machine learning model operates in relation to a channel-estimation-based beam management function that outputs a channel estimation result (S014b). The relation may comprise a parallel relation in which the machine learning model operates in parallel to the current channel-estimation-based beam management function. The relation may comprise a substitution relation in which the machine learning model operates in substitution for the current channel-estimation-based beam management function. For example, an output of the machine learning model operates replace an output of the current channel-estimation-based beam management function. In an embodiment, the model inference unit 104 operates the trained machine learning model 105b to output a beam operation advice as an inference output. The gNB 40 transmits the beam operation advice as an inference output in an indication to the UE 10 (S015b). The UE 10 receives the indication comprising the beam operation advice.

The UE 10 performs a beam operation based on the beam operation advice and the channel estimation result (S016b). In an embodiment, the actor 103 performs a beam operation based on the beam operation advice and the channel estimation result as shown in S016b.

With reference to FIG. 6, the UE 10 collects data units for beam management based on machine learning, wherein the data units associate a plurality of beams with a plurality of attributes, and each data unit in the data units associates a beam with at least one attribute (S010a). In an embodiment, the data collection unit 101 performs the collecting of data units in the S010a. The UE 10 reports the data units to the gNB 20 (S011a). The gNB 20 receives the data units.

The gNB 20 collects data units for beam management based on machine learning, wherein the data units associate a plurality of beams with a plurality of attributes, and each data unit in the data units associates a beam with at least one attribute (S010b). In an embodiment, the data collection unit 101 performs the collecting of data units in the S010b. The gNB 40 may also reports the data units to the gNB 20. The gNB 20 receives the data units.

The gNB 20 trains a machine learning (ML) model by inputting the data units to a machine learning model (S012c). In an embodiment, the model training unit 102 trains the machine learning model 105a by inputting the data units to the machine learning model 105a as shown in S012c and obtains the trained machine learning model 105b.

The gNB 20 operates the trained machine learning model to output a beam operation advice, wherein the machine learning model operates in relation to a channel-estimation-based beam management function that outputs a channel estimation result (S014c). The relation may comprise a parallel relation in which the machine learning model operates in parallel to the current channel-estimation-based beam management function. The relation may comprise a substitution relation in which the machine learning model operates in substitution for the current channel-estimation-based beam management function. For example, an output of the machine learning model operates replace an output of the current channel-estimation-based beam management function. In an embodiment, the model inference unit 104 operates the trained machine learning model 105b to output a beam operation advice as an inference output. The gNB 20 transmits the beam operation advice as an inference output in an indication to the gNB 40 (S015c-1). The gNB 40 transmits the beam operation advice as an inference output in an indication to the UE 10 (S015c-2). The UE 10 receives the indication comprising the beam operation advice.

The UE 10 performs a beam operation based on the beam operation advice and the channel estimation result (S016c). In an embodiment, the actor 103 performs a beam operation based on the beam operation advice and the channel estimation result as shown in S016b.

In an embodiment, the gNB 20 is a serving base station (i.e., a source base station) of the UE 10 during a handover operation of the UE 10 while the gNB 40 is a target base station of the UE 10 during the handover operation of the UE 10.

### 1.1 the Data Collection for ML in Beam Management:

To improve beam selection, in an embodiment of the disclosure, a selected beam is predicted according to historical data units. The most straightforward method is to report geometric information (e.g., a trace or position) of a UE and a beam (e.g., a beam name, a beam index, or a beam identifier) serving the UE to a machine learning model and the machine learning model predicts the next move of the UE and the next beam for the UE. User privacy may be taken into consideration in some embodiments.

The gNB may collect UE measurements (e.g., L1-SINR, RSRP, RSRQ, hypothetical BLER) on one or more beams to predict the next move of the UE 10. Some embodiments of the disclosure provide data formats of the collected data. Note that L1-SINR stands for layer one reference signal received power (RSRP), RSRQ stands for reference signal received quality (RSRQ), and hypothetical BLER stands for block error rate (BLER).

The UE 10 may report the collected data units in response to a request from the gNB 20 or triggers reporting of the collected data units periodically in response to a timer in the UE 10 or sporadically (in an aperiodic way) in response to a trigger event. In an embodiment, the UE 10 is pre-configured to report the collected data with a certain interval.

The output(s) of the machine learning model for beam management may provide useful effects can be in two ways.
Proactive method: For example, the machine learning model (also known as an ML neural network) predicts a beam as the predicted beam at time t+n (e.g., in units of milliseconds, mini-slot, sub-slots, slots, frames, subframes, or RS measurement periods) according to input to the machine learning model at time t (e.g., in units of milliseconds, mini-slot, sub-slots, slots, frames, subframes, or RS measurement periods) when measurements until time t are reported and fed into the machine learning model, where t is a natural number representing a time location, and n is a natural integer representing an offset to the time location. The machine learning model is deployed in the gNB 20 or the UE 10. The predicted beam to switch to serves as a beam operation advice to the UE 10 before time t+n according to a timeline of the UE 10, and the UE 10 performs a beam operation, such as selecting the predicted beam or transmitting a new beam request to the gNB 20, for the predicted beam based on the beam operation advice.
Reactive method: For example, the machine learning model predicts a beam as the predicted beam at time t+n (e.g., in units of milliseconds, mini-slot, sub-slots, slots, frames, subframes, or RS measurement periods) according to input to the machine learning model at time t (e.g., in units of milliseconds, mini-slot, sub-slots, slots, frames, subframes, or RS measurement periods) when measurements until time t are reported and fed into the machine learning model, where tis a natural number representing a time location, and n is a natural integer representing an offset to the time location. The machine learning model may be installed in the gNB 20. The gNB 20 performs a beam operation, such as beam sweeping or sending an indication as a beam operation advice to the UE 10 before time t+n. The UE 10 performs a beam operation, such as selecting the predicted beam or transmitting a beam request to the gNB 20, for the predicted beam based on the indication.

The validity of Machine Learning model output is used for beam management. As an example, the validity time of the machine learning model output is a time window centered on the prediction time instance. This time window is equal to the time unit between the collected two data units. In another example, this time window begins from the indication of the current output from the machine learning model and ends at the indication of the next output of the machine learning model.

### 1.1.1. Data Format:

In a scenario, the UE 10 is within a serving cell of the gNB 20. In a scenario given in later embodiments, the UE 10 interacts with at least one gNB. Let us consider two gNB as an example.

In an embodiment, an example of the data format of the collected data units is [beam name, location]. The beam in a data unit is a beam through which the UE 10 connects to the gNB 20. For example, the data units comprise a sequence of data units {[beam B1, position1], [beam B1 position2], [beam B2, position3], . . . }. Each of [beam B1, position1], [beam B1 position2], [beam B2, position3], and other data pairs in the sequence forms a data unit. The position1, position2, and position3 can be in the form of coordinates, e.g., (x, y), of the UE 10. The interval between two entries in the sequence is a time unit, e.g., 10 ms.

In another example, to avoid user privacy problems, the position information is not included in the sequence. The data format is represented as a UE-connected beam and a connection duration, thus associating UE-connected beams with connection duration. For example. The data units comprise a sequence {[beam B1, 1 ms], [beam B1, 1 ms], [beam B2, 2 ms], . . . }, in the form of [beam name/index, connection duration]. Each data pair enclosed in a square bracket is a data unit. The machine learning model may be trained to output a predicted beam so as to avoid rapid beam switching.

In another example, the data format is {beam B1, beam B2, beam B2, beam B2, beam B3, . . . }, where the connected duration is not explicitly indicated in the data units. Each of the beams separated by commas is a data unit. The beams in the collected data units are equally sampled at different time units spaced apart with a time interval (e.g., in units of milliseconds, mini-slot, sub-slots, slots, frames, subframes, or RS measurement periods). In an example, a sequence {beam B1, beam B2, beam B2, beam B2, beam B3, . . . } denotes that the UE 10 connected to beam B1 in time unit 1, beam B2 in time unit 2, beam B2 time unit 3, beam B2 in time unit 4, beam B3 in time unit 5, and so on.

In another example, the data format is described as a UE-connected beam and a measurement of the UE connected beam, thus associating UE connected beams with measurements of the beams. For example. The data units comprise a sequence {[beam B1, meansuremt1], [beam B1, measurement1], [beam B2, measurement3], . . . }. Each data pair enclosed in a square bracket is a data unit in the form of [beam name/index, measurement]. Each measurement in the sequence may comprise an L1-SINR, and/or RSRP, and/or RSRQ, and/or hypothetical BLER of a beam.

In another example, the data format comprises a structure of quantized measurement values of some/all beams of a gNB, such as the gNB 20. For example, the collected data units comprise a sequence shown as:

{
beam B1: 1, 0, 1, 0, 0, 0,...
beam B2: 1, 0, 1, 0, 0, 0,...
beam B3: 1, 0, 1, 0, 0, 0,...
beam B4: 1, 1, 1, 1, 1, 0,...
beam B5: 0, 1, 1, 1, 1, 1,...
...},

where each row forms a data unit in the collected data units;
the “1” in each row means the beam in the row in a time unit has a measurement value greater than a threshold; and
“0” in each row means the beam in the row in a time unit has a measurement value no greater than the threshold.

In the embodiment, the measurement on the beam associated by the data unit comprises a quantized measurement value. The quantized measurement value is one when the beam in a time unit has a measurement value greater than a threshold. The quantized measurement value is zero when the beam in a time unit has a measurement value no greater than the threshold. The gNB 20 may configure the threshold for the UE as a default value.

In an alternative embodiment, the “1s/0s” in the sequence are replaced by the values of the measurement values before quantization, where the connected duration is not explicitly indicated. The measurement values in the sequence are measured and quantized in each of time units spaced apart with an interval.

In another example, the beam names/indexes in above examples are denoted by quasi-co-location (QCL) relationships or transmission configuration indicator (TCI) states.

In another example, each data unit associates a beam with a beam measurement, such as in form of {[beam name/index, (acc_measurement, lea_measurement)]}.
The acc_measurement indicates the first measurement when a UE (e.g., the UE 10) is connected with this beam.
The lea_measurement indicates the last measurement before a UE (e.g., the UE 10) leaves this beam.

In another example, the feedback results are collected for beam management. Both the predicted beam from Machine Learning and the beam from channel estimation are continuously monitored/measured. The corresponding data are collected. In one example, the afterwards processing can be comparing the machine learning model output and the beam from channel estimation, indicating whether the prediction of the ML model is accurate e.g., with one bit “0/1” (yes/no). This step can be processed at UE and reported to gNB. As an alternative, only the UE measurement is reported to gNB. The processing is completed at gNB.

In another example, because the data collection is very frequent and cost lots of resources. Instead, to reduce the data report times, the time averaged measurements of the data units are reported. Whether to enable the time averaged data collection is configurable. The configuration is an RCC signaling or DCI. Besides, the starting time t_0 is the configuration time. And the values in the data units are averaged across time in a time window, t_report_window. The t_report_window is configured by RRC signaling or DCI field from a gNB. Or the t_report_window is reported from UE and/or confirmed by a gNB according to UE capability. As an alternative to this example, the maximum/minimum of the values in the data units are reported across a time window t_report_window.

In another example, the data units are packaged across a time window t_report_window and reported/collected. The t_report_window is configured by RRC signaling or DCI field from a gNB. Or the t_report_window is reported from UE and/or confirmed by a gNB according to UE capability.

As an example, data of cross cell measurement, the data is labeled with a notation of a second gNB in embodiments in section 1.1.1, and by default the data is not labeled by a notation of the connected gNB. In this case, the SSBs (synchronization signal burst) from other gNBs nearby can be detected and received from UE. Thus, the UE is able to report the measurement of other gNBs.

1.1.2. Data Collection and Data Sharing Between Two gNBs:

Data sharing between wireless communication devices may facilitate a sequence sufficiently long for prediction by the machine learning model. A capability indicating whether the data units are sharable is configurable.

In an embodiment, the data units are collected from a first radio node (e.g., gNB 20) and a second radio node (e.g., gNB 40). The second radio node may share its collected data units with the first radio node via x2/xn interface.

In some embodiments, whether a wireless communication device, such as the first radio node or the second radio node) can share its collected data is configurable, for example, by 1 bit. The bit represents a data sharing capability of the wireless communication device. For example, value 1 (i.e., enabled) represents the bit that the wireless communication device can share data for beam management to another wireless communication device, and value 0 (i.e., disabled) of the bit represents that the wireless communication device cannot share data for beam management to another wireless communication device]. The data sharing capability disabled can facilitate privacy protection.

In some examples, both the first node and the second node are base stations. The first node queries the second node whether it is able to share its collected data. The configuration is from operators, or higher layers (e.g., RRC) or the core network.

In some examples, the data format detailed in embodiments in section 1.1.1 may be pre-fixed, or a post-fixed with an identifier of a gNB, such as a cell ID or a physical cell identifier (PCI) in an SSB, which performs the data collection. The collected data are labeled with the gNB performing the data collection. As an example, data of cross cell measurement, the data is labeled with a notation of a second gNB in embodiments in section 1.1.1, and by default, the data is not labeled by a notation of the connected gNB. The notation is the PCI (physical cell identifier). In some embodiments, one of the first radio node or the second radio node requests the data from the other one of the first radio node or the second radio node.

In another example, data collection comprises this UE working status from second gNB, e.g., the predictive beam quality, in terms of L1-SINR, and/or RSRP, and/or RSRQ, and/or hypothetical BLER. In some examples, this second gNB indicates whether UE is handed over from the predicted beam to another beam in a short time t_h. If the handover occurs in a short time t_h, due to pingpang effects occurs, or the beam quality is not as good as predicted. This result is recorded by this another gNB and indicated to the first gNB.

### Beam Mapping: To Reduce the Beam Number (Parameters)

The collected data units may be labeled with gNB/UE positions. For example, each data unit may comprise a position of the UE 10 and/or a position of a base station, such as the gNB 20 or the gNB 40) that shares the collected data. The beam of a base station has its spatial information (e.g., geographical locations, directions, and/or angles) of beams, each of which cover a specific area in a certain direction. In sharing the collected data units between two base stations, a mapping function between the two base stations to map the beams of a first base station in the two base stations to a second base station in the two base stations according to spatial relations between beams of the two base stations.

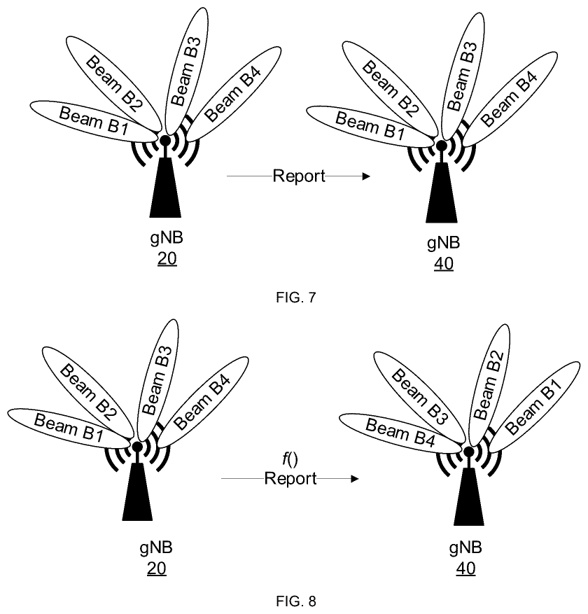

With reference to FIG. 7, for example, the gNB 20 reports its collected data units directly to the gNB 40. The data units are labeled with an identifier of the gNB 20, together with the beam sequences.

With reference to FIG. 8, the gNB 20 reports the collected data units through a mapping function ƒ ( ) to the gNB 40. The beams of gNB 20 are mapped to the corresponding beams of gNB 40. The mapping function maps an index/name of a Beam in gNB 20 to an index/name of a Beam in gNB 40.

That is, beam B1 of gNB 40 is mapped to beam B4 of gNB 40, Beam B2 of gNB 20 is mapped to Beam B3 of gNB 40, Beam B4 of gNB 20 is mapped to beam B4 of gNB 40. Thus, in the embodiment, parameters to be input to the machine learning model for training the machine learning model can be reduced.

### 1.1.3 Beam Indication During Handover.

In an embodiment, the UE 10 is handed over from gNB 20 to gNB 40.

During a handover operation, data collection, training of the machine learning model, and the beam operation may be performed in different entities (i.e., different wireless communication devices). Embodiments of the disclosure with the machine learning model located in different wireless communication devices are given in the following.

### The Machine Learning Model at gNB 40 (the Target Node):

At a machine learning model inference stage of the machine learning model, the gNB 20 reports the data units collected by the gNB 20 to the gNB 40.

The UE 10 may also report data units comprising measurements on beams of the gNB 20, which are collected by the UE 10, to the gNB 40. The machine learning model is trained by the gNB 40 using the collected data units from one or more of the gNB 20, the UE 10, and the gNB 40 itself. Beam selection performed by the UE 10 for the determination of a selected beam (i.e., the predicted beam) can be interfered with by the output of the machine learning model. For example, the gNB 40 sends to the UE 10 an indication indicating the predicted beam.

In the response to the indication, the UE 10 uses the indicated beam to perform a random access channel (RACH) procedure (i.e., a random access procedure).

If the UE 10 is not connected to the indicated beam, the gNB 40 switches the UE 10 to the indicated beam after a radio resource control (RRC) connection between the UE 10 and the gNB 40 is established.

### The Machine Learning Model at gNB 20 (the Source Node):

At the machine learning model inference stage, no historical data units will be reported from the gNB 20 to the gNB 40.

The UE 10 may also report data units comprising measurements on beams of the gNB 20, which are collected by the UE 10, to the gNB 20. The machine learning model is trained by the gNB 20 using the collected data units from one or more of the gNB 20, the UE 10, and the gNB 40 itself. The gNB 20 may indicate predicted beam to the gNB 40 via X2/Xn interface between the gNB 20 and the gNB 40. Beam selection performed by the UE 10 for the determination of a selected beam (i.e., the predicted beam) can be interfered with by the output of the machine learning model. For example, the gNB 40 sends to the UE 10 an indication indicating the predicted beam.

In the response to indication, the UE 10 uses the indicated beam to perform a random access channel (RACH) procedure (i.e., a random access procedure).

If the UE 10 is not connected to the indicated beam, the gNB 40 switches the UE 10 to the indicated beam after a radio resource control (RRC) connection between the UE 10 and the gNB 40 is established.

The predicted beam may be indicated to UE 10 through a RRC reconfiguration message RRCReconfiguration message to indicate the predicated beams of gNB 40 via the association between RACH resources of the gNB 40 and SSB(s) of the gNB 40.

### 1.2 Data Collection for Beam Failure Recovery.

An embodiment of the disclosure provides a procedure of machine-learning-based beam failure recovery comprising collecting data units for beam failure recovery, using the collected data units to train the machine learning model, and performing the beam failure detection using the output of the machine learning model. The machine learning model can output a probability of beam failure. The gNB/UE decides whether to proceed with a beam failure request to address the beam failure according to this probability.

Whether the UE 10's capability of machine-learning-based beam failure recovery is defined as a capability. In this case, the machine learning model can either be deployed at gNB and/or at UE. If the UE 10 does not support such capability, the machine learning model should not be deployed at UE and can be deployed at a base station, such as the gNB 20 and/or 40. As an alternative, when the UE does not support such capability, no machine learning based signaling/advice will be provided to UE.

### 1.2.1 the Inputs and Outputs of the Machine Learning Model for Beam Failure Recovery:

In an embodiment, the data units input to the machine learning model is the historical information of beam failure, and the output of the machine learning model is the probability of the beam failure.

### A First Example of a Data Format for Beam Failure Recovery:

In a first example, a format of the data unit input to the machine learning model is an input matrix of:
{beam B1: measurement at time t-m, measurement at time t-(m−1), . . . measurement at time t};
where each data unit comprises a measurement value of a beam (e.g., beam B1 in the example) at a time unit.

In the first example, a format of the output from the machine learning model is an output matrix of:
{Probability of beam failure occurrence with beam B1 at time t+n};
where the output of the machine learning model comprises a probability of beam failure associated with a beam at a time unit, beam B1 belongs to a candidate beam set which the UE 10 is monitoring for beam failure detection, t is an integer location index, n is a non-negative integer (i.e., a natural number), and m is a non-negative integer.

### A Second Example of a Data Format for Beam Failure Recovery:

In a second example, a format of the data unit input to the machine learning model is an input matrix of:
{beam B1: measurement at time t-m, measurement at time t-(m−1), . . . measurement at time t;
beam B2: measurement at time t-m, measurement at time t-(m−1), . . . measurement at time t;
beam B3: measurement at time t-m, measurement at time t-(m−1), . . . measurement at time t}
   where each data unit comprises a measurement value of a beam (e.g., beam B1, B2, or B3 in the example) at a time unit.

In the second example, a format of the output from the machine learning model is an output matrix of:
{Probability of beam failure occurrence with beam B1 at time t+n;
Probability of beam failure occurrence with beam B2 at time t+n;
Probability of beam failure occurrence with beam B3 at time t+n}
where each data element in the output of the machine learning model comprises a probability of beam failure associated with a beam at a time unit;
beam B1, beam B2, and beam B3 belong to the candidate beam sets where the UE 10 is monitoring, n is a positive integer, and m is a non-negative integer.

In an embodiment, the input is the historical measurements of each beam, and the output is one bit for one beam indicating whether the beam failure occurs, i.e., yes/no (0/1).

### A Third Example of a Data Format for Beam Failure Recovery:

In a third example, a format of the data unit input to the machine learning model is an input matrix of:
{beam B1: measurement at time t-m, measurement at time t-(m−1), . . . measurement at time t}
where each data unit comprises a measurement value of a beam (e.g., beam B1 in the example) at a time unit.

In the third example, a format of the output from the machine learning model is an output matrix of:
{(0/1) whether beam failure occurrence with beam B1 at time t+n}
where each data element in the output of the machine learning model comprises a quantized probability of beam failure associated with a beam at a time unit;
beam B1 belongs to the candidate beam set where the UE 10 is monitoring for beam failure detection, and n is an integer greater than zero.

### A Fourth Example of a Data Format for Beam Failure Recovery:

In a fourth example, a format of the data unit input to the machine learning model is an input matrix of:
{beam B1: measurement at time t-m, measurement at time t-(m−1), . . . measurement at time t;
beam B2: measurement at time t-m, measurement at time t-(m−1), . . . measurement at time t;
beam B3: measurement at time t-m, measurement at time t-(m−1), . . . measurement at time t;}
where each data unit comprises a measurement value of a beam (e.g., beam B1, B2, or B3 in the example) at a time unit.

In the fourth example, a format of the output from the machine learning model is an output matrix of:
{(0/1) whether beam failure occurrence with beam B1 at time t+n,
(0/1) whether beam failure occurrence with beam B2 at time t+n,
(0/1) whether beam failure occurrence with beam B3 at time t+n,}
   where each data element in the output of the machine learning model comprises a quantized probability of beam failure associated with a beam at a time unit;
beam B1, beam B2, and beam B3 belong to the candidate beam set where the UE 10 is monitoring for beam failure detection, n is a positive integer, and m is a non-negative integer.

### A Fifth Example of a Data Format for Beam Failure Recovery:

In a fifth example, a format of the data unit input to the machine learning model is an input matrix of:
{beam B11: measurement at time t-m11, measurement at time t-(m11-1), . . . measurement at time t;
beam B21: measurement at time t-m21, measurement at time t-(m21-1), . . . measurement at time t;
beam B22: measurement at time t-m22, measurement at time t-(m22-1), . . . measurement at time t;
beam B23: measurement at time t-m23, measurement at time t-(m23-1), . . . measurement at time t;
}
where each data unit comprises a measurement value of a beam (e.g., beam B11, B21, B22, or B23 in the example) at a time unit.

In the fifth example, a format of the output from the machine learning model is an output matrix of:

{(0/1) whether beam failure occurrence with beam B11 at time t+n,
Probability of the beam B21 as the new candidate beam at time t+n,
Probability of the beam B22 as the new candidate beam at time t+n,
Probability of the beam B23 as the new candidate beam at time t+n,
}

where each row of the output matrix comprises a data element, each data element in the output of the machine learning model comprises a quantized probability of beam failure associated with a beam in a candidate beam set at a time unit or a probability of beam failure associated with a new candidate beam at a time unit;
beam B11 belong to the candidate beam sets where the UE 10 is monitoring for beam failure detection and beam B21, beam B22, and beam B23 belong to a candidate beam set for new beam selection, n is a positive integer, and m11, m21, m22, m23 is a non-negative integer. In an embodiment, some or all of m11, m21, m22, m23 have the same value. As another example, m11, m21, m22, m23 have different values.

In another example, the output of the machine learning model, is a predicted UE measurement of the monitored beam at time tin, where n is a positive integer. The UE measurement here is RSRP, and/or RSRQ, and/or L1-SINR, and/or hypothetical BLER.

### 1.2.2 Data Collection for Beam Failure Recovery:

The UE 10 may report measurement, such as L1-SINR of quasi-co-located (QCLed) physical downlink control channel (PDCCH), CSI-RS, or SSB, as collected data units to a base station (e.g., the gNB 20 or 40). The data units for beam failure recovery may comprise:

### Hypothetical BLER:

The UE 10 may report the hypothetical BLER to a base station (e.g., the gNB 20 or 40).
UE 10 may report the averaged hypothetical BLER to a base station (e.g., the gNB 20 or 40).

### Quantized Measurement Values to Reduce the Overhead:

The UE 10 reports quantized measurement values to a base station (e.g., the gNB 20 or 40). The quantized measurement values may be obtained with reference to a threshold. For example, the quantized measurement value is obtained by comparing the measurement value (e.g., hypothetical BLER) to a threshold. If the measurement value is greater than the threshold, the UE 10 quantized the measurement value to binary 1. If the measurement value is not greater than the threshold, the UE 10 quantized the measurement value to binary 0.
   Embodiments Regarding Machine Learning Model Deployment are Detailed in the Following. A Machine Learning Model Deployed at UE:

In an embodiment, the machine learning model is deployed in the UE 10. The advantage is that the UE 10 does not need to frequently report measurement results to the serving gNB, such as the gNB 20. In this case, the trained machine learning model should be downloaded to UE 10. The UE 10 may send a beam failure request if the probability of beam failure output by the machine learning model is greater than a threshold. The threshold may be configured by a base station, such as the gNB 20 or 40.

In an embodiment, the machine-learning-based beam failure recovery replaces the conventional counter-based beam failure recovery.

In another embodiment, the machine-learning-based beam failure recovery co-exists with the conventional counter-based beam failure recovery.

### A Machine Learning Model Deployed at gNB:

A base station (e.g., the gNB 20 or 40) is more powerful than a UE, such as the UE 10, and can run complex ML models. In an embodiment, the UE 10 reports data units, including measurement results on beams, to a base station (e.g., the gNB 20 or 40) running the machine learning model.

In an embodiment, the machine-learning-based beam failure recovery replaces the conventional counter-based beam failure recovery.

In another embodiment, the machine-learning-based beam failure recovery co-exists with the conventional counter-based beam failure recovery.

In the embodiment where the machine learning model is deployed at a base station, the base station may indicate the beam switching (e.g., a predicted bean as a new beam in the operation of beam switching). When a probability output by the machine learning model predicts that beam failure will happen, the base station may send an indication (e.g., downlink control information (DCI)) to trigger a non-contention-based RACH for the UE 10. The indication may also indicate a predicted beam.

When the predicted beam is the same as a preferred beam that the UE 10 obtains from a channel-estimation-based beam management function that outputs a channel estimation result, the UE 10 proceeds the RACH with the beam.

When the predicted beam is different from a preferred beam that the UE 10 obtains from a channel-estimation-based beam management function that outputs a channel estimation result, the UE may execute operations in one or more of the following options for PCell/SPCell:
Option 1: If the predicted beam is in the candidate beam set, the UE 10 uses the predicted beam to perform RACH. If the predicted beam is not in the candidate beam set, the UE 10 uses the preferred beam to perform RACH.
Option 2: The UE 10 uses the preferred beam to perform RACH.
Option 3: The UE 10 uses the predicted beam to perform RACH.
Option 4: The UE 10 uses both of the predicted beam and the preferred beam to perform RACH.
Default option: The UE 10 uses the preferred beam selected from the channel-estimation-based beam management function.

In another case, new data is sent with above at least one option instead of RACH, for beam failure recovery in SCell.

Whether the new candidate beam q_{new} can be selected according to the prediction provided by the machine learning model and is configurable, for example, via RRC signaling or DCI signaling. In another example, whether the new candidate beam q_new can be selected according to the ML model prediction is configurable, for example, via RRC signaling or DCI signaling. And there is a default configuration. For example, by default, the predicted new beam q_new is not provided by gNB to UE when the ML model is deployed at the gNB side. The providing of q_new is enabled at UE request and/or according to UE capability.

1.3 Data Set with Field Data:

In some scenarios, the field data sets, such as beam failure data, for training the machine learning model can be difficult to obtain. As a result, sources of the data sets become limited.
Field data may be used for dataset construction for training, validation and test of the machine learning model for the selected use cases.
   The field data may be divided into different portions. For example, a portion of the field data can form a data set which is used for test of the machine learning model.
In an embodiment, there are priorities for the portions of the field data for the making of training, validation, and test of the machine learning model.
In an embodiment, the portions of field data are organized as.
   A test data set;
   A validation data set; and
   A training date set.
   A priority Pₜₑₛₜ of the test data set, a priority Pᵥₐₗ of the validation data set, and a priority Pₜᵣₐᵢₙ of the training data set are arranged in a descending order, i.e., Pₜₑₛₜ≥ Pᵥₐₗ≥ Pₜᵣₐᵢₙ≥0. This consideration follows the design of model generalization. For an ML model to work properly, the model should work with unseen data.
As an alternative, the portions of field data are organized as follows. A priority Pₜₑₛₜ of the test data set, a priority Pₜᵣₐᵢₙ of the training data set, and a priority Pᵥₐₗ of the validation data set are arranged in a descending order, i.e., Pₜₑₛₜ≥ Pₜᵣₐᵢₙ≥ Pᵥₐₗ≥0. This design is for the easy training of the machine learning model.

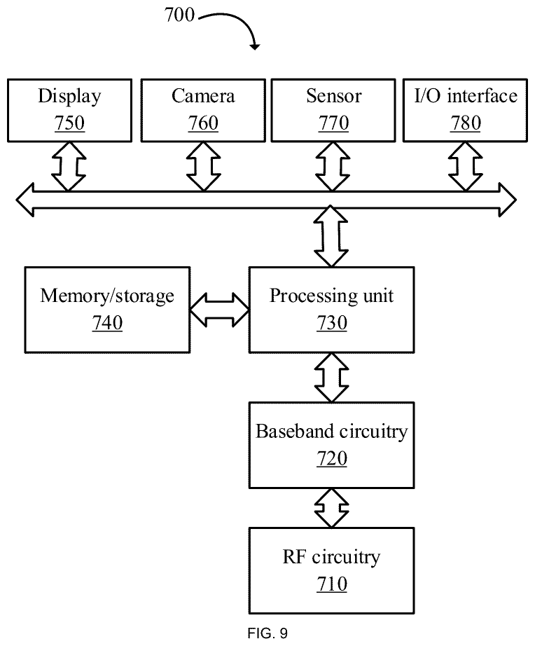

FIG. 9 is a block diagram of an example system 700 for wireless communication according to an embodiment of the present disclosure. Embodiments described herein may be implemented into the system using any suitably configured hardware and/or software. FIG. 24 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that can be adopted in 3GPP specification to create an end product.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random-access memory (RAM), a floppy disk, or other kinds of media capable of storing program codes.

The disclosure provides a data collection method for beam management based on machine learning. The invention provides embodiments to address problems in beam management.
Some embodiments of the disclosure include data collection in beam management. Various schemes of data collection may be used for different functions in beam management. In particular, the data collection can be performed at one gNB and shared between two gNBs or performed at two gNBs.
Some embodiments of the disclosure provide predictive beam failure recovery and facilitate efficient beam failure detection and robust beam selection.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A data collection method for beam management based on machine learning, executable in at least one wireless communication device, comprising:
collecting data units for beam management based on machine learning, wherein the data units associate a plurality of beams with a plurality of attributes, and each data unit in the data units associates a beam with at least one attribute.

2. The method of claim 1, wherein the data unit comprises a beam name, a beam index, or a beam identifier of the beam; and
wherein the data unit comprises a quasi-co-location (QCL) relationship or a transmission configuration indicator (TCI) state denoting the beam.

3. (canceled)

4. The method of claim 1, wherein the at least one attribute in the data unit comprises measurement on the beam associated by the data unit; and
wherein the measurement on the beam associated by the data unit comprises a reference signal received power (RSRP), reference signal received quality (RSRQ), or hypothetical block error rate (BLER).

5. (canceled)

6. The method of claim 4, wherein the measurement on the beam associated by the data unit comprises a quantized measurement value;
wherein the quantized measurement value is one when the beam in a time unit has a measurement value greater than a threshold; and
the quantized measurement value is zero when the beam in a time unit has a measurement value no greater than the threshold.

7. (canceled)

8. The method of claim 1, wherein the at least one attribute in the data unit comprises location information of the at least one wireless communication device.

9. The method of claim 1, wherein the at least one attribute in the data unit comprises a connection duration on the beam associated by the data unit.

10. The method of claim 1, wherein a capability indicating whether the data units are sharable is configurable.

11. The method of claim 1, further comprising:
training a machine learning (ML) model by inputting the data units to the machine learning model;
operating the trained machine learning model to output a beam operation advice, wherein the machine learning model operates in relation to a channel-estimation-based beam management function that outputs a channel estimation result; and
performing a beam operation based on the beam operation advice and the channel estimation result.

12. (canceled)

13. The method of claim 11, wherein the relation comprises a parallel relation in which the machine learning model operates in parallel to the channel-estimation-based beam management function.

14. The method of claim 11, wherein the relation comprises a substitution relation in which the machine learning model operates in substitution for the current channel-estimation-based beam management function.

15. The method of claim 11, wherein the beam operation advice output from the machine learning model comprises a probability of beam failure associated with the beam at a time unit.

16. The method of claim 11, wherein the beam operation advice output from the machine learning model comprises a quantized probability of beam failure associated with the beam at a time unit.

17. The method of claim 11, wherein each data element in an output of the machine learning model comprises a quantized probability of beam failure associated with a beam in a candidate beam set at a time unit or a probability of beam failure associated with a new candidate beam at a time unit.

18. The method of claim 11, wherein the at least one wireless communication device comprises a user equipment (UE), and the machine learning model is downloaded to the UE.

19. The method of claim 11, wherein the at least one wireless communication device comprises a base station, and the machine learning model is deployed in the base station.

20-24. (canceled)

25. The method of claim 20, wherein the at least one wireless communication device further comprises a user equipment (UE), the UE receives the beam operation advice from the base station;
wherein the beam operation advice indicates a predicted beam; and
when the predicted beam is the same as a preferred beam that the UE obtains from a channel-estimation-based beam management function, the UE proceeds a random access procedure with the predicted beam.

26. The method of claim 20, wherein the at least one wireless communication device further comprises a user equipment (UE), the UE receives the beam operation advice from the base station;
wherein the beam operation advice indicates a predicted beam; and
when the predicted beam is different from a preferred beam that the UE obtains from a channel-estimation-based beam management function, the UE executes one or more of operations in the following:
if the predicted beam is in a candidate beam set, the UE uses the predicted beam to perform a random access procedure;
if the predicted beam is not in the candidate beam set, the UE uses the preferred beam to perform the random access procedure;
the UE uses the preferred beam to perform the random access procedure;
the UE uses the predicted beam to perform the random access procedure; and
the UE uses both of the predicted beam and the preferred beam to perform the random access procedure.

27. A wireless communication device comprising:
a processor, configured to call and run a computer program stored in a memory, to cause a device in which the processor is installed to execute the method of claim 1.

28. A chip, comprising:
a processor, configured to call and run a computer program stored in a memory, to cause a device in which the chip is installed to execute the method of claim 1.

29. A computer-readable storage medium, in which a computer program is stored, wherein the computer program causes a computer to execute the method of claim 1.

30-31. (canceled)
